(19) United States
(12) Patent Application Publication
(10) Pub. No.: US 2008/0278054 A1
(43) Pub. Date: Nov. 13, 2008

(54) Display Device, Screen Panel and Phosphor Material Composition Thereof

(76) Inventors: Chun-Min Hu, Keelung City (TW); Ching-Hsiang Tseng, Taoyuan County (KR); Lichun Yang, Fujian Province (CN); William Tang, Fujian Province (CN); Donghua Lan, Fujian Province (CN)

Correspondence Address: J C PATENTS, INC., 4 VENTURE, SUITE 250, IRVINE, CA, 92618, US

(21) Appl. No.: 11/568,029

(22) PCT Filed: May 3, 2005
(86) PCT No.: PCT/IB05/01185

§ 371 Date: Oct. 17, 2006

(30) Foreign Application Priority Data
May 4, 2004 (TW) 93112468
Apr. 26, 2005 (TW) 94113191

(51) Int. Cl. H01J 1/62; C09K 11/08; H01J 29/10

(52) U.S. Cl. 313/486; 252/301.4 R; 313/461

(57) ABSTRACT

In an embodiment, a phosphor material composition comprises a phosphor powder and an additive, wherein the additive has an amount in a range of about 0.1%˜20% of the phosphor powder in weight. The material of the additive is selected from the group consisting of an energy absorption material and a conductive material and a combination thereof. In another embodiment, a phosphor material composition including a phosphor powder and an additive is provided, wherein the additive has an amount of 2.8 ppm˜32000 ppm. The material of the additive is also selected from the group consisting of an energy absorption material, a conductive material and a combination thereof.

### CROSS-REFERENCE TO RELATED APPLICATION

This application claims the priority benefit of Taiwan application serial no. 93112468 and Taiwan application serial no. 94113191, filed 4 May 2004 and Apr. 26, 2005, respectively.

### BACKGROUND OF THE INVENTION

1. Field of Invention

The present invention relates to a display device, a screen panel and a phosphor material composition thereof. More particularly, the present invention relates to a cathode ray tube (CRT) display device, a screen panel and a phosphor material composition thereof.

2. Description of Related Art

Upon an information society, more and more needs for a display to serve as an information medium are increased. The industry develops related display technology with full power. The CRT display has occupied the market for a long time because of its superior display quality and mature technology. Currently, the general home-use CRT display is continuously developed to have a large display area and a high resolution. Large screen CRT displays are main products for the 33 or more inches CRT display. The large screen CRT displays are catalogued into a projection-type CRT display and a fiber-type CRT display. The projection type CRT uses an optical system to project an image to a large screen.

A projection type CRT display device includes an electromagnetic bunch, an electromagnetic deflection device and a phosphor material. For increasing brightness of an enlarged projection image of the projection type CRT display device, high-voltage accelerated electrons can be used. For increasing the resolution of an enlarged projection image of the projection type CRT display device, a phosphor material having shorter light emitting time can be used. However, life time of the projection type CRT display device is decreased since the phosphor material is burned by the high-voltage accelerated electrons and high flow rate.

Various solutions are provided to solve the burning problem of the phosphor material. The first solution is to use spherical phosphor material, which can improve burning resistance by increasing packing density, but the process of producing the spherical phosphor material is too difficult to apply to production line. The second solution is to apply refractory material such as PO₄ or Al₂O₃ to a phosphor material layer, but burning resistance is not improved apparently. The third solution for improving burning resistance disclosed by U.S. Pat. Nos. 4,032,760, 4,032,760 and 4,521,720, is to change the circuit design to prevent the current from stimulating the phosphor material layer at the same position for a long time period.

### SUMMARY OF THE INVENTION

Accordingly, one objective of the present invention is to provide a phosphor material composition capable of increasing its burning resistance.

The another objective of the present invention is to provide a screen panel capable of increasing its life time.

The further objective of the present invention is to provide a display device capable of increasing its life time.

To achieve these and other advantages and in accordance with the purpose of the invention, as embodied and broadly described herein, the present invention provide a phosphor material composition. The phosphor material composition comprises a phosphor powder and an additive. The additive has an amount in a range of about 0.1%˜20% of the phosphor powder in weight, and the additive is selected from the group consisting of an energy absorption material, a conductive material and a combination thereof.

The present invention also provides a screen panel. The screen panel comprises a transparent substrate and a phosphor material layer on the transparent substrate. The material constituting the phosphor material layer comprises a phosphor powder and an additive, and the additive has an amount in a range of about 0.1%˜20% of the phosphor powder in weight, and the additive is selected from the group consisting of an energy absorption material, a conductive material and a combination thereof.

The present invention further provides a display device. The display device comprises a screen panel, an electron gun and a deflection control module for electron beam. The screen panel comprises a transparent substrate and a phosphor material layer on the transparent substrate. The material constituting the phosphor material layer comprises a phosphor powder and an additive, and the additive has an amount in a range of about 0.1%˜20% of the phosphor powder in weight, and the additive is selected from the group consisting of an energy absorption material, a conductive material and a combination thereof. The electron gun provides an electron beam toward the phosphor material layer of the screen panel. The deflection control module for electron beam is disposed between the electron gun and the screen panel for controlling the deflection of the electron beam.

The present invention further provides a display device. The display device comprises a screen panel, an electron gun, a deflection control module for electron beam, a reflection module and a display panel. The screen panel comprises a transparent substrate and a phosphor material layer on the transparent substrate. The material constituting the phosphor material layer comprises a phosphor powder and an additive, and the additive has an amount in a range of about 0.1%˜20% of the phosphor powder in weight, and the additive is selected from the group consisting of an energy absorption material, a conductive material and a combination thereof. The electron gun provides an electron beam toward the phosphor material layer of the screen panel so as to project an image through a first light path. The deflection control module for electron beam is disposed between the electron gun and the screen panel for controlling the deflection of the electron beam. The reflection module is disposed on the first light path and reflects the projected image. The display panel is disposed on a second light path of the reflected image.

The present invention provides a phosphor material composition. The phosphor material composition comprises a phosphor powder and an additive. The additive has an amount in a range of 2.8 ppm˜32000 ppm, and the additive is selected from the group consisting of an energy absorption material, a conductive material and a combination thereof.

The present invention also provides a screen panel. The screen panel comprises a transparent substrate and a phosphor material layer on the transparent substrate. The material constituting the phosphor material layer comprises a phosphor powder and an additive, and the additive has an amount in a range of 2.8 ppm˜3200 ppm, and the additive is selected from the group consisting of an energy absorption material, a conductive material and a combination thereof.

The present invention further provides a display device. The display device comprises a screen panel, an electron gun and a deflection control module for electron beam. The screen panel comprises a transparent substrate and a phosphor material layer on the transparent substrate. The material constituting the phosphor material layer comprises a phosphor powder and an additive, and the additive has an amount in a range of 2.8 ppm˜32000 ppm, and the additive is selected from the group consisting of an energy absorption material, a conductive material and a combination thereof. The electron gun provides an electron beam toward the phosphor material layer of the screen panel. The deflection control module for electron beam is disposed between the electron gun and the screen panel for controlling the deflection of the electron beam.

The present invention further provides a display device. The display device comprises a screen panel, an electron gun, a deflection control module for electron beam, a reflection module and a display panel. The screen panel comprises a transparent substrate and a phosphor material layer on the transparent substrate. The material constituting the phosphor material layer comprises a phosphor powder and an additive, and the additive has an amount in a range of 2.8 ppm˜32000 ppm, and the additive is selected from the group consisting of an energy absorption material, a conductive material and a combination thereof. The electron gun provides an electron beam toward the phosphor material layer of the screen panel so as to project an image through a first light path. The deflection control module for electron beam is disposed between the electron gun and the screen panel for controlling the deflection of the electron beam. The reflection module is disposed on the first light path and reflects the projected image. The display panel is disposed on a second light path of the reflected image.

In the present invention, since the phosphor material composition has the energy absorption material or/and the conductive material therein that can absorb or conduct excess electric energy or thermal energy, the burning resistance of the phosphor material composition can be improved.

In the present invention, the screen panel has a phosphor material composition comprising the energy absorption material or/and the conductive material, therefore life time of the screen panel can be increased.

Furthermore, in the display device of the present invention, the screen panel has a phosphor material composition comprising the energy absorption material or/and the conductive material, thereby life time of the screen panel can be increased.

It is to be understood that both the foregoing general description and the following detailed description are exemplary, and are intended to provide further explanation of the invention as claimed.

### BRIEF DESCRIPTION OF THE DRAWINGS

The accompanying, drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a cathode ray tube according to one preferred embodiment of the present invention.

FIG. 2 illustrates a projection type cathode ray tube display device according to the second preferred embodiment of the present invention.

### DESCRIPTION OF THE PREFERRED EMBODIMENTS

The present invention provides a phosphor material composition to increase the burning resistance of the phosphor material composition in the display device. In addition to a phosphor powder, the phosphor material composition comprises an additive mixed with the phosphor powder. The additive is selected from the group consisting of an energy absorption material, a conductive material and a combination thereof. Since the phosphor material composition has the energy absorption material or/and the conductive material therein that can absorb or conduct excess electric energy or thermal energy, the burning resistance of the phosphor material composition can be improved. Examples of a cathode ray tube and a projection type display device using the phosphor material composition of the present invention are described in detail as examples as follows, but not limit in that. Certainly, the phosphor material composition of the present invention can be applied to other display devices using phosphor material such as plasma display panels (PDP), field emitting displays (FED) and surface-conduction electron-emitter displays (SED).

### First Embodiment

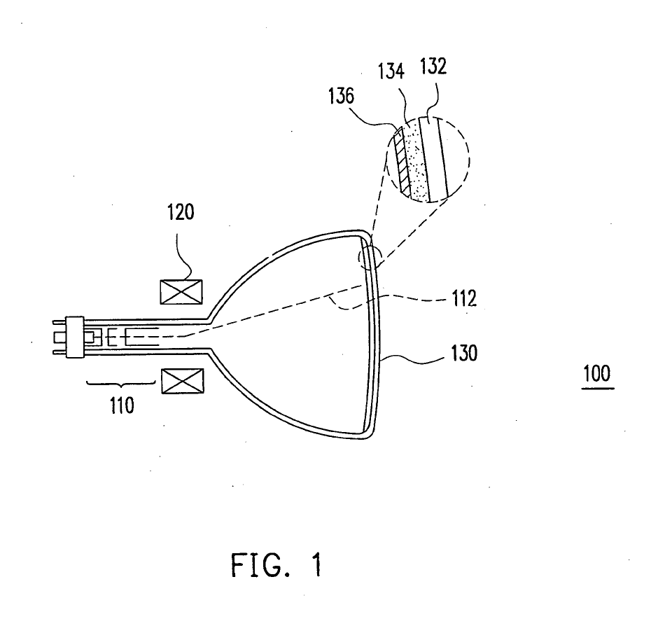

FIG. 1 illustrates a cathode ray tube according to one preferred embodiment of the present invention. Referring to FIG. 1, a cathode ray tube display device 100 includes an electron gun 110, an electron beam deflection control module 120 and a screen panel 130. The screen panel 130 comprises a transparent substrate 132 and a phosphor material layer 134 on the transparent substrate 132. The material constituting the phosphor material layer 134 comprises a phosphor powder and an additive, and the additive has an amount in a range of about 0.1%˜20% of the phosphor powder in weight, and the additive is selected from the group consisting of an energy absorption material, a conductive material and a combination thereof. The phosphor material layer 134 can be formed by using a spray coating process, precipitation process or other applicable processes. The additive can absorb or conduct excess electric energy or thermal energy or improve the burning resistance of the phosphor material layer 134. In an embodiment, the screen panel 130 further comprises a metal film 136 thereon to cover the phosphor material layer 134 so as to prevent an over-accumulation of secondary electrons produced by that the electron beam collides the phosphor material composition.

The electron gun 110 provides an electron beam 112 toward the phosphor material layer 134 of the screen panel 130. The electron beam deflection control module 120 is arranged between the electron gun 110 and the screen panel 130 to control the deflection of the electron beam. The electron beam deflection control module 120 can be an electrostatic deflection control module, an electromagnetic deflection control module or other applicable control module.

In one embodiment of the present invention, the material constituting the transparent substrate 132 comprises a glass material or other transparent material. Further, in the phosphor material layer 134, the phosphor powder is selected from red phosphor powder, green phosphor powder or blue phosphor powder. The additive comprises an energy absorption material and/or a conductive material. In one embodiment of the present invention, the additive has a particle size of about 0.01 to 10 μm. The material constituting the additive can be selected in a manner described in detail below.

The material constituting the aforementioned energy absorption material comprises an inorganic energy absorption material, for example, an inorganic ultra violet absorption material. In one embodiment, the inorganic ultra violet absorption material is selected from the group consisting of titanium oxide, zinc oxide and a combination thereof. The titanium oxide is an anatase.

The conductive material comprises an inorganic conductive material, for example, a transparent inorganic conductive material. In one embodiment of the present invention, the transparent inorganic conductive material is selected from the group consisting of antimony tin oxide (ATO) and indium tin oxide (ITO) and a combination thereof.

Furthermore, in the cathode ray tube of the present invention, since the phosphor material composition has the energy absorption material or/and the conductive material therein that can absorb or conduct excess electric energy or thermal energy, the burning resistance of the phosphor material composition can be improved. Thereby, the life time of the cathode ray tube can be increased.

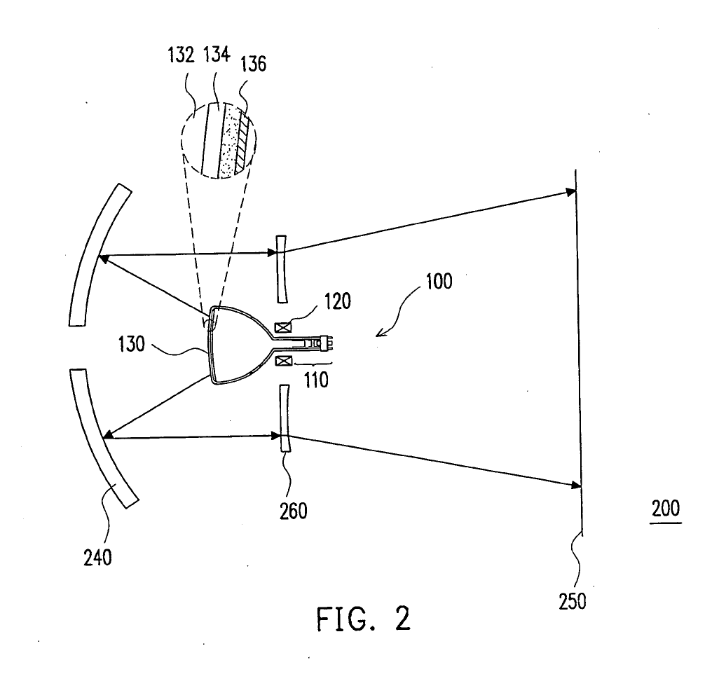

The phosphor material composition of the present invention can be applied to a projection type cathode ray tube display device. FIG. 2 illustrates a projection type cathode ray tube display device according to the second preferred embodiment of the present invention. Referring to FIG. 2, a projection type cathode ray tube display device 200 comprises a cathode ray tube 100, a reflection module 240 and a display panel 250. The electron gun 110 provides an electron beam toward the phosphor material layer 134 of the screen panel 130 so as to project an image through a first light path. The reflection module 240 is disposed on the first light path projected from the screen panel 130 and reflects the projected image. The display panel 250 is disposed on a second light path of the reflected image. The reflection module 240 can be a spherical reflector or other applicable reflection module, for example. The display panel 250 can be a white projection screen, for example. In order to improve image quality, the display panel 250 further comprises an optical compensation module 260 such as a correcting lens disposed on the reflection light path of the reflection module 240 between the reflection module 240 and the display panel 250. The reflection module 240 and the display panel 250 output a large-size image, so as to improve output image quality of the projection type cathode ray tube display device 200.

Similarly, in the aforementioned projection type cathode ray tube display device 200, a screen panel 130 includes a transparent substrate 132 and a phosphor material layer 134, and preferably further comprises a metal film 136, as shown in FIG. 1. Specifically, the material constituting the phosphor material layer 134 comprises a phosphor powder and an additive, wherein the additive has an amount in a range of about 0.1%˜20% of the phosphor powder in weight. The additive is selected from the group consisting of an energy absorption material, a conductive material and a combination thereof, and therefore it can absorb or conduct excess electric energy or thermal energy or improve the burning resistance of the phosphor material composition 134. The energy absorption material and the conductive material are similar to those in the aforementioned embodiments, and therefore the related description is omitted here.

In the projection type cathode ray tube display device, the burning of the phosphor material composition is serious because of using high potential and high flow rate of electron beam. In the present invention, since the phosphor material composition has excellent burning resistance, life time of the projection type cathode ray tube display device can be increased.

The following examples illustrate the burning resistance of the phosphor material composition of the present invention.

TABLE 1

| | Phosphor | | | Time of |
|---|---|---|---|---|
| | material | | Grain | burning |
| | compo- | | size | resistance |
| | sition | Additive | (μm) | (hours) |
| Example 1 | G78 | Antimony | 1 | 18.5 |
| | | tin oxide 1% | | |
| Example 2 | G78 | Indium tin | 1 | 10 |
| | | oxide 1% | | |
| Example 3 | G78 | Titanium | 1 | 8 |
| | | oxide 1% | | |
| Comparing | G78 | None | — | 3 |
| Example | | | | |

Referring to Table 1, green phosphor powder (G78, available from Nichia Corporation) as a phosphor material composition is used in examples 1 to 3 and comparing example. Example 1 contains antimony tin oxide 1% having grain size of 1 μm. Example 2 contains indium tin oxide 1% having grain size of 1 μm. Example 3 contains titanium oxide 1% having grain size of 1 μm. Example 4 does not contain any additive in the green phosphor powder G78. According to table 1, because of adding antimony tin oxide, indium tin oxide or titanium oxide into the green phosphor powder G78, the phosphor material composition has longer time of burning resistance than the green phosphor powder G78 without additive. Furthermore, as a result of adding antimony tin oxide into the green phosphor powder G78, the phosphor material composition has better burning resistance. Various amounts and various grain sizes of antimony tin oxide added into the green phosphor powder G78 are described as follows.

TABLE 2

| | | Grain | | |
|---|---|---|---|---|
| | Phosphor | size of | Amount | Time of |
| | material | additive | of | burning |
| | compo- | (ATO) | additive | resistance |
| | sition | (μm) | (ATO) | (hours) |
| Example 4 | G78 | 1 | 0.1% | 5 |
| Example 5 | G78 | 1 | 0.5% | 10 |
| Example 6 | G78 | 1 | 1% | 18.5 |
| Example 7 | G78 | 1 | 5% | 20 |
| Comparing | G78 | — | None | 3 |
| Example | | | | |

Table 2 illustrates various amount of antimony tin oxide having the same grain size 1 μm are added into the green phosphor powder G78 (available from Nichia Corporation) of examples 4 to 7. According to the exhibition of table 2, the phosphor material compositions containing various amount of additive have longer time of burning resistance than the green phosphor powder G78 without additive.

TABLE 3

| | | Grain | | |
|---|---|---|---|---|
| | Phosphor | size of | Amount | Time of |
| | material | additive | of | burning |
| | compo- | (ATO) | additive | resistance |
| | sition | (μm) | (ATO) | (hours) |
| Example 8 | G78 | 0.01 | 1% | 4 |
| Example 9 | G78 | 0.1 | 1% | 12 |
| Example 10 | G78 | 1 | 1% | 18.5 |
| Example 11 | G78 | 6 | 1% | 22 |
| Comparing Example | G78 | — | None | 3 |

Table 3 illustrates various grain sizes of 1% antimony tin oxide are added into the green phosphor powder G78 (available from Nichia Corporation) of examples 8 to 11. According to the exhibition of table 3, the phosphor material compositions with various grain sizes of additive have longer time of burning resistance than the green phosphor powder G78 without additive.

The aforementioned examples illustrate addition of the additive of the present invention into the green phosphor powder can improve the burning resistance of the phosphor material composition. In other examples, the additive of the present invention added into blue or red phosphor powder can also improve the burning resistance of the phosphor material composition.

### Second Embodiment

The phosphor material composition in the second embodiment is similar to that of the first embodiment, and the difference therebetween includes the amount and particle size of the additive and is described as follows.

The phosphor material composition in the second embodiment comprises a phosphor powder and an additive, wherein the additive has an amount in a range of 2.8 ppm˜32000 ppm, and the additive is also selected from the group consisting of a energy absorption material, a conductive material and a combination thereof. The additive has a particle size less than 100 nm, for example. The phosphor powder is selected from red phosphor powder, green phosphor powder or blue phosphor powder.

In an embodiment, the additive is an energy absorption material. The energy absorption material is selected from the group consisting of titanium oxide, zinc oxide and a combination thereof, and the energy absorption material has an amount in a range of 45 ppm˜383 ppm.

In another embodiment, the additive is a conductive material. The conductive material is selected from the group consisting of antimony tin oxide (ATO), indium tin oxide (ITO) and a combination thereof. In particular, if the conductive material is ATO, the conductive material has an amount in a range of 2.8 ppm˜26.8 ppm. If the conductive material is ITO, the conductive material has an amount in a range of 1600 ppm˜32000 ppm.

In the second embodiment, the mixing method for the phosphor powder and the additive is different from that in the first embodiment, and the additive of the second embodiment has a particle size less than that in the first embodiment so that the amount of the additive in the phosphor material composition in the second embodiment is relatively low. However, both the phosphor material compositions in the first and second embodiment have good burning resistance.

In details, the mixing method in the first embodiment is that directly mixing the phosphor powder and the additive by mechanical stirring, wherein the additive used in the first embodiment has a particle size of 0.01˜10 μm.

However, in the second embodiment, a additive slurry and a phosphor slurry are prepared, and then these two slurries are mixed. The method of preparing the additive slurry comprises grinding the additive having large particle size (0.01˜10 μm, for example) to form a powder having a particle size less than 100 nm; and mixing the powder with a liquid to form a slurry having a predetermined ratio (higher than 10000 ppm, for example), wherein the liquid is a mixture of water and diethylamine. In addition, the method of preparing the phosphor slurry comprises mixing the phosphor powder with a liquid to form a slurry, wherein the liquid is a mixture of water and potassium silicate.

After the additive slurry and the phosphor slurry are mixed to form a mixed slurry and the mixed slurry is coated on a substrate, a analysis step is performed by inductively coupled plasma atomic emission spectrometer (ICP-AES). The analyzed result is that the amount of the additive remained in the phosphor material is in a range of 2. 8 ppm˜32000 ppm.

Thereafter, a burning resistance testing for the phosphor material composition having the additive of 2.8 ppm˜3200 ppm is carried out. The testing result is that even if the additive in the phosphor material composition has lower amount (2.8 ppm˜32000 ppm), the phosphor material composition has good burning resistance.

Several Examples are described as follows for illustration but not limit the present invention herein.

TABLE 4

| | TiO2 | | ATO | | ITO | |
|---|---|---|---|---|---|---|
| Phosphor | Addition | Residual | Addition | Residual | Addition | Residual |
| powder | (ppm) | (ppm) | (ppm) | (ppm) | (ppm) | (ppm) |
| Red | 10000 | 45 | 10000 | 2.8 | 50000 | 25700 |
| Green | 150000 | 383 | 10000 | 26.8 | 100000 | 32000 |
| Blue | 10000 | 133 | 10000 | 5.6 | 50000 | 1600 |

TABLE 5

| | Burning resistance | Burning resistance | Burning resistance | Burning resistance |
|---|---|---|---|---|
| | time when the | time when the | time when the | time when the |
| | phosphor material | phosphor material | phosphor material | phosphor material |
| | does not includes | includes TiO₂ | includes ATO | includes ITO |
| Phosphor | any additive therein | therein | therein | therein |
| powder | (hour) | (hour) | (hour) | (hour) |
| Red | 3 | 3 | 3 | 3 |
| | (seriously burned | (lightly burned | (lightly burned | (lightly burned |
| | trace) | trace) | trace) | trace) |
| Green | 5.7 | 6 | 14.5 | 8 |
| Blue | 7.5 | 14.2 | 16 | 12.6 |

Table 4 shows several examples comprising red, green and blue phosphor powder mixed with the additive (TiO_{2,} ATO, ITO) of more than 10000 ppm and the analyzed additive residual thereof. Table 5 shows burning resistance testing result of each example in Table 4. As shown in Table 4 and Table 5, the phosphor material composition having the additive of 2.8 ppm˜32000 ppm therein has good burning resistance comparing with the phosphor material having no additive therein.

It should be noted that in the second embodiment the particle size of the additive (less than 100 nm) is smaller that of the phosphor powder, and the mixing method for the additive and the phosphor powder is not by mechanical stirring so that a portion of the additive may be lost during mixing and the amount of the additive remained on the phosphor powder is reduced. Since the material and particle size of the red, green and blue phosphor powders are different, the amount of the additive remained on the red, green and blue phosphor powders are different.

Similarly, the phosphor material of the second embodiment can also be applied to a screen panel and a display device. In other words, the phosphor material of the second embodiment can be coated on a substrate so as to form a screen panel. A display device constructed by the screen panel, an electron gun and an electron beam deflection control module is also provided. A protecting CRT display device constructed by the screen panel, an electron gun, an electron beam deflection control module, a reflection module and display panel is also provided. The detail description for the elements of the screen panel, the display device and the protecting CRT display device is similar or the same to that in the first embodiment.

For the foregoing, compared with the phosphor material of the prior art, the phosphor material composition comprising an additive having an amount of about 0.1%˜20% or 2.8 ppm˜32000 ppm of the present invention has good burning resistance.

Compared with the prior art which PO₄ or Al₂O₃ is applied to the phosphor layer, the means of fabricating the screen panel of the present invention by adding additive into the phosphor powder can increase life time and decrease the process time.

The means of fabricating the screen panel of the present invention by adding additive into the phosphor powder does not need changing scan electron beam and can further increase life time of the phosphor material.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A phosphor material composition, comprising:
a phosphor powder; and
an additive having an amount in a range of 0.1-20% of the phosphor powder in weight, and comprising an ultra-violet absorption material and a conductive material.

3. The phosphor material composition of claim 1, wherein the ultra-violet absorption material is selected from the group consisting of titanium oxide, zinc oxide and a combination thereof.

4. The phosphor material composition of claim 1, wherein the inorganic conductive material comprises a transparent conductive material.

5. The phosphor material composition of claim 4, wherein the transparent conductive material is selected from the group consisting of antimony tin oxide, indium tin oxide and a combination thereof.

6. The phosphor material composition of claim 1, wherein the additive has a particle size of 0.01 μm to 10 μm.

7. The phosphor material composition of claim 1, wherein the phosphor powder is selected from red phosphor powder, green phosphor powder or blue phosphor powder.

8. A screen panel, comprising:
a transparent substrate; and
a phosphor material layer formed on the transparent substrate, wherein the material constituting the phosphor material layer comprises a phosphor powder and an additive, and the additive has an amount in a range of 0.1-20% of the phosphor powder in weight, and the additive comprises an ultra-violet absorption material and a conductive material.

10. The screen panel of claim 8, wherein the conductive material comprises a transparent conductive material.

11. The screen panel of claim 8, wherein the additive has a particle size of 0.01 μm to 10 μm.

12. The screen panel of claim 8, further comprising a metal film on the phosphor material layer.

13. A display device, comprising:
a screen panel comprising a transparent substrate and a phosphor material layer on the transparent substrate, wherein the phosphor material layer comprises a phosphor powder and an additive, and the additive has an amount in a range of about 0.1-20% of the phosphor powder in weight, and the additive comprises an ultra-violet absorption material and a conductive material;
an electron gun for providing a electron beam toward the phosphor material layer of the screen panel; and
an electron beam deflection control module disposed between the electron gun and the screen panel for controlling the deflection of the electron beam.

15. The display device of claim 13, wherein the conductive material comprises a transparent conductive material.

16. The display device of claim 13, wherein the additive has a particle size of 0.01 μm to 10 μm.

17. A display device, comprising:
a screen panel comprising a transparent substrate and a phosphor material layer on the transparent substrate, wherein the phosphor material layer comprises a phosphor powder and an additive, and the additive has an amount in a range of about 0.1-20% of the phosphor powder in weight, and the additive comprises an ultra-violet absorption material and a conductive material;
an electron gun for providing a electron beam toward the phosphor material layer of the screen panel so as to project an image through a first light path;
an electron beam deflection control module disposed between the electron gun and the screen panel for controlling the deflection of the electron beam;
a reflection module disposed on the first light path and reflecting the projected image; and
a display panel disposed on a second light path of the reflected image.

19. The display device of claim 17, wherein the conductive material comprises a transparent conductive material.

20. The display device of claim 17, wherein the additive has a particle size of 0.01 μm to 10 μm.

21. A phosphor material composition, comprising:
a phosphor powder; and
an additive having an amount in a range of 2.8-32000 ppm, and comprising an ultra-violet absorption material and a conductive material.

22. The phosphor material composition of claim 21, wherein the ultra-violet absorption material is selected from the group consisting of titanium oxide, zinc oxide and a combination thereof, and the ultra-violet absorption material has an amount in a range of 45-383 ppm.

23. The phosphor material composition of claim 21, wherein the conductive material is selected from the group consisting of antimony tin oxide (ATO), indium tin oxide (ITO) and a combination thereof.

24. The phosphor material composition of claim 23, wherein if the conductive material is ATO, the conductive material has an amount in a range of 2.8-26.8 ppm.

25. The phosphor material composition of claim 23, wherein if the conductive material is ITO, the conductive material has an amount in a range of 1600-32000 ppm.

26. The phosphor material composition of claim 21, wherein the additive has a particle size less than 100 nm.

27. The phosphor material composition of claim 21, wherein the phosphor powder is selected from red phosphor powder, green phosphor powder or blue phosphor powder.

28. A screen panel, comprising:
a transparent substrate; and
a phosphor material layer formed on the transparent substrate, wherein the material constituting the phosphor material layer comprises a phosphor powder and an additive, and the additive has an amount in a range of 2.8-32000 ppm, and the additive comprises an ultra-violet absorption material and a conductive material.

29. The screen panel of claim 28, wherein the ultra-violet absorption material is selected from the group consisting of titanium oxide, zinc oxide and a combination thereof, and the ultra-violet absorption material has an amount in a range of 45-383 ppm.

30. The screen panel of claim 28, wherein the conductive material is selected from the group consisting of antimony tin oxide (ATO), indium tin oxide (ITO) and a combination thereof.

31. The screen panel of claim 30, wherein if the conductive material is ATO, the conductive material has an amount in a range of 2.8-26.8 ppm.

32. The screen panel of claim 30, wherein if the conductive material is ITO, the conductive material has an amount in a range of 1600-32000 ppm.

33. The screen panel of claim 28, wherein the additive has a particle size less than 100 nm.

34. The screen panel of claim 28, further comprising a metal film on the phosphor material layer.

35. A display device, comprising:
a screen panel comprising a transparent substrate and a phosphor material layer on the transparent substrate, wherein the phosphor material layer comprises a phosphor powder and an additive, and the additive has an amount in a range of 2.8-32000 ppm, and the additive comprises an ultra-violet absorption material and a conductive material;
an electron gun for providing a electron beam toward the phosphor material layer of the screen panel; and
an electron beam deflection control module disposed between the electron gun and the screen panel for controlling the deflection of the electron beam.

36. The display device of claim 35, wherein the ultra-violet absorption material is selected from the group consisting of titanium oxide, zinc oxide and a combination thereof, and the ultra-violet absorption material has an amount in a range of 45-383 ppm

37. The display device of claim 35, wherein the conductive material is selected from the group consisting of antimony tin oxide (ATO), indium tin oxide (ITO) and a combination thereof.

38. The display device of claim 37, wherein if the conductive material is ATO, the conductive material has an amount in a range of 2.8-26.8 ppm.

39. The display device of claim 37, wherein if the conductive material is ITO, the conductive material has an amount in a range of 1600-32000 ppm.

40. The display device of claim 35, wherein the additive has a particle size less than 100 nm.

41. A display device, comprising:
a screen panel comprising a transparent substrate and a phosphor material layer on the transparent substrate, wherein the phosphor material layer comprises a phosphor powder and an additive, and the additive has an amount in a range of 2.8-32000 ppm, and the additive comprises an ultra-violet absorption material and a conductive material;
an electron gun for providing a electron beam toward the phosphor material layer of the screen panel so as to project an image through a first light path;
an electron beam deflection control module disposed between the electron gun and the screen panel for controlling the deflection of the electron beam;
a reflection module disposed on the first light path and reflecting the projected image; and
a display panel disposed on a second light path of the reflected image.

42. The display device of claim 41, wherein the ultra-violet absorption material is selected from the group consisting of titanium oxide, zinc oxide and a combination thereof, and the ultra-violet absorption material has an amount in a range of 45-383 ppm.

43. The display device of claim 41, wherein the conductive material is selected from the group consisting of antimony tin oxide (ATO), indium tin oxide (ITO) and a combination thereof.

44. The display device of claim 43, wherein if the conductive material is ATO, the conductive material has an amount in a range of 2.8-26.8 ppm.

45. The display device of claim 43, wherein if the conductive material is ITO, the conductive material has an amount in a range of 1600-32000 ppm.

46. The display device of claim 41, wherein the additive has a particle size less than 100 nm.
